(19) United States
(12) Patent Application Publication
(10) Pub. No.: US 2005/0283482 A1
(43) Pub. Date: Dec. 22, 2005

(54) Method and device for selection and transfer of computer object between computers

(76) Inventor: Lai-Chen Lai, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,092

(22) Filed: May 10, 2005

(30) Foreign Application Priority Data
Jun. 17, 2004 (TW) 93117454

(51) Int. Cl. G06F 17/30

(52) U.S. Cl. 707/10

(57) ABSTRACT

A method for selection and transfer a computer object between computers is employed in a computer networking environment including at least two computer devices and a network interface coupling between the computer devices. A computer object selection/transfer pen is used to select a computer object from a source computer device and an object ID of the computer object is picked up by the pen. The pen is then moved to a target computer device and the object ID is transferred to the target computer device. The target computer searches and retrieves the computer object from the source computer device via the network interface. The network interface can be a cable-based computer network interface or a wireless network interface and can alternatively include a servo computer to perform transfer of the computer object.

### FIELD OF THE INVENTION

The present invention relates generally to the selection and transfer of computer object, and in particular to a method for selection and transfer of computer objects between computer devices and a device for performing the method.

### BACKGROUND OF THE INVENTION

In the field of computer, in addition to the development and upgrading of hardware and software, user-friendliness is another challenge for the computer business. Due to the complexity of the newly developed computer system, it becomes difficult for general consumers to know how to properly operate newly developed computers. Thus, a simplified and user-friendly man-machine interface is of great help and benefit to the general consumers who attempt to use the computers.

Generally, most of the newly developed hardware and software are quite user-friendly. For example, in a Window based operation system, a computer user is allowed to move or transfer computer files or file folders by “dragging” the computer files or file folders. Even better, locking function is also provided, which allows the user to select and lock the computer files or file folders without uninterrupted holding buttons of for example a computer mouse in moving or transferring files. This technique, however, is only applicable in a single machine computer system and is cannot help the computer user to move or transfer computer files or file folders between two or more computers.

Currently, file transfer between two computers in a multiple machine computer system is done by forming cable connection or a networking system between the computers and establishing communication protocol between the computers, by which files can be transferred properly from one computer to the other.

Another conventional way to transfer files between two computers, which also allows a computer user to move files by “dragging”, is to establish an infrared connection between the computers. This technique suffers the requirement of properly aligning the computers with each other in order to allow for establishment of infrared connection between the computers.

These techniques, although effective in moving files between computers, is still tedious and difficult for general computer users and thus it is desired to have a method for moving computer files between computers that resembles the way that people used to moving physical articles in order to enhance user-friendliness of the computers.

### SUMMARY OF THE INVENTION

An objective of the present invention is to provide a method for selection and transfer of a computer object from a source computer to a target computer in a networked multiple-machine computer system, which allows a user to transfer the computer object in a manner resembling move of physical articles, wherein the user, after selecting the computer object in the source computer, physically moves the computer object from the source computer to the target computer with the help of a transfer device.

Another objective of the present invention is to provide a method for transferring a selected computer object from a source computer to a target computer in a networked multiple-computer system, which combines direct transfer of the object and transmission of contents of the object via the network so as to best suit mental activity of general consumers.

A further objective of the present invention is to provide a device for selection and transfer of a computer object between computers, which allows for random selection and transfer of computer objects to simplify the transfer and management of computer files.

In accordance with the present invention, in a computer networking environment comprised of at least two computer devices and a network interface coupling the computer devices together, a computer object selection/transfer pen is employed to select, in a source computer device, at least one computer object to be transferred and an object ID of the selected computer object is transferred to the computer object selection/transfer pen. The computer object selection/transfer pen is then moved to a target computer device and the object ID is transferred from the computer object selection/transfer pen to the target computer device. Thereafter, the target computer, based on the object ID, retrieves the computer object from the source computer device via the network interface.

The network interface can be cable-based network or a wireless interface that connects between the computer devices of the system. Alternatively, the network interface comprises a servo computer that governs the transfer of the computer object itself, after the object ID is received by the target computer device. The computer object can be a computer file or a computer file folder.

### BRIEF DESCRIPTION OF THE DRAWINGS

The present invention will be apparent to those skilled in the art by reading the following description of the best mode for carrying out a method of the present invention, as well as preferred embodiment of a device for carrying out the method of the present invention, with reference to the attached drawings, in which:

FIG. 1 is a schematic view illustrating a computer networking system comprised of at least two computer device linked to each other by a network interface for embodying a method for selection and transfer of a computer object between the computer device via the network interface in accordance with the present invention;

FIG. 2 is a schematic view illustrating a computer networking system for embodying the present invention in which the network interface is formed by a cable-based network system;

FIG. 3 is similar to FIG. 2 but showing the network interface formed by a wireless network system;

FIG. 4 is a block circuit diagram of control circuit of a computer object selection/transfer pen in accordance with the present invention;

FIG. 5 is a flowchart of the method for selection and transfer of a computer object between two computer devices in accordance with the present invention;

FIG. 6 shows an example of a table list of pen ID (PEN_ID), computer object ID (OBJ_ID), and device ID (DEV_ID), which is used in the method in accordance with the present invention;

FIG. 7 is a schematic view illustrating a computer networking system for embodying the present invention in which the network interface is formed by a cable-based network system comprising a servo computer;

FIG. 8 is similar to FIG. 7 but showing the network interface formed by a wireless network system comprising a servo computer; and

FIG. 9 a flowchart of the method for selection and transfer a computer object between two computer devices in accordance with the present invention.

### DETAILED DESCRIPTION OF THE PREFERRED EMBODIMENTS

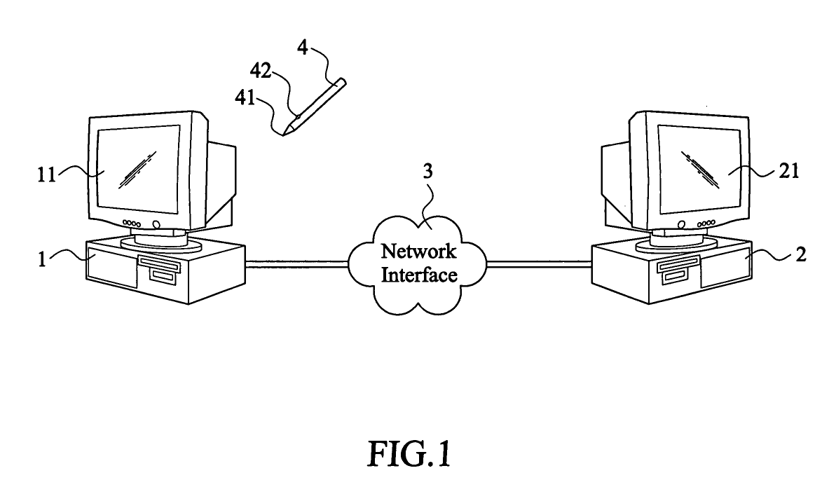

With reference to the drawings and in particular to FIG. 1, a computer networking environment constructed in accordance with the present invention is formed by connecting at least two computer devices, which are respectively designated with reference numerals 1, 2, with a network interface that is broadly designated with reference numeral 3. Each computer device 1, 2 comprises a display 11, 21. In the computer networking environment of the present invention that is formed by the computer devices 1, 2, a computer object selection/transfer pen, designated with reference numeral 4, is provided. The computer object selection/transfer pen 4 is selectively movable toward the display 11 of the first computer device 1 or the display 21 of the second computer device 2 to carry out selection and transfer of computer objects between the two computer devices 1, 2.

Each computer device 1, 2 is provided with a device ID (identification code), such as network address of each computer device in the computer networking environment. The computer object selection/transfer pen 4 is also provided with a pen ID, which allows the computer object selection/transfer pen 4 to be identified in the computer networking environment.

The term “computer object” used herein includes computer files and computer file folders. The term “transfer” used herein means data (file/file folder) copy and data (file/file folder) move that are commonly used in regular computer operation.

The computer object selection/transfer pen 4 has a front tip 41, comprising a depression-actuateable element, serving as a selector that allows a user to select computer objects. Alternatively, the front tip 41 of the computer object selection/transfer pen 4 comprises electromagnetic means for performing selection in an electromagnetic manner. Another example of the front tip 41 of the computer object selection/transfer pen 4 comprises a sharp end that cooperates with a touch panel, such as the touch screen of a tablet computer, to select computer objects by pointing the computer objects on the display 11, 21. In the embodiment illustrated, the computer devices 1, 2 are provided touch-panel type display 11, 21.

The computer object selection/transfer pen 4 also comprises a function key 42, such as a depressible button functioning as a confirmation button or other user-configured function key, which is actuated when depressed, for example.

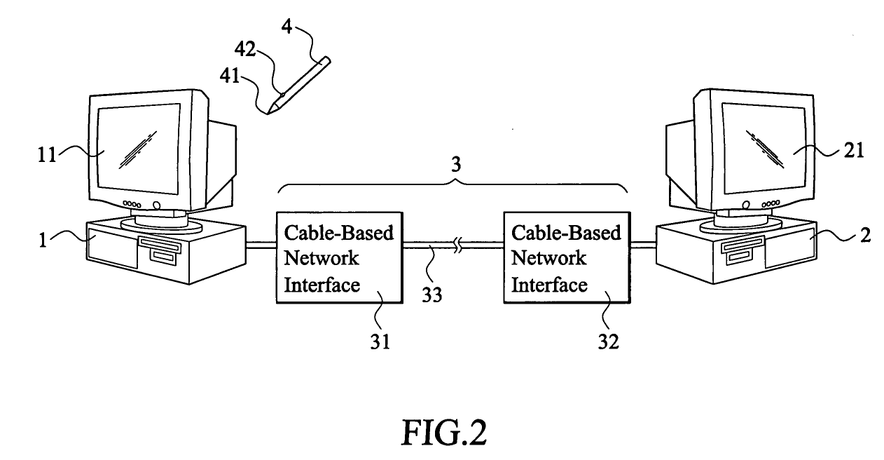

The network interface 3 can be embodied in several different ways. For example, and as shown in FIG. 2, each computer device 1, 2 comprises a cable-based network interface 31, 32. The interfaces 31, 32 are connected to each other by a cable 33. The interfaces 31, 32 and the cable 33 together form a cable-based network between the computer devices 1, 2 and a computer networking environment for the computer devices 1, 2 is established.

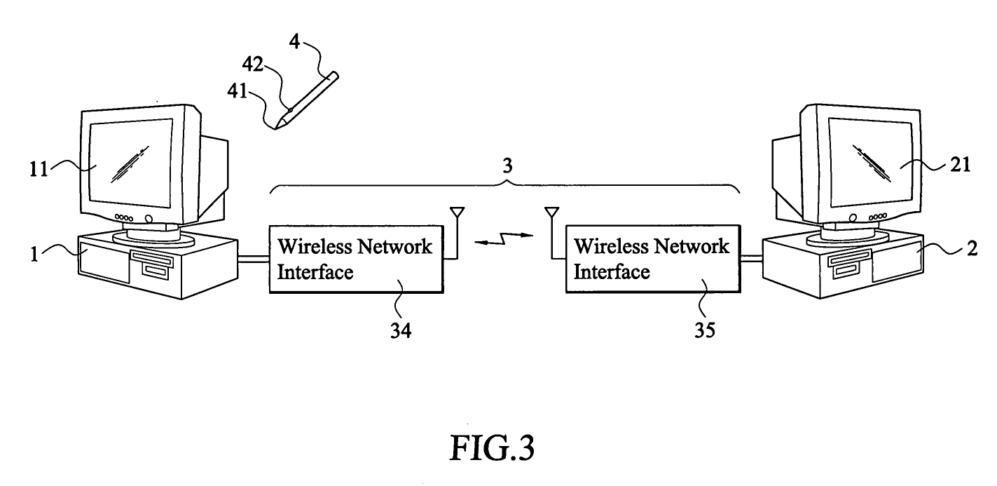

Alternatively, a wireless network interface can be established between the computer devices 1, 2, an example of which is illustrated in FIG. 3. Each computer device 1, 2 is equipped with a wireless network interface 34, 35 and wireless communication or exchange of data and signals is performed between the interfaces 34, 35. Thus, a wireless computer networking environment is formed between the computer devices 1, 2.

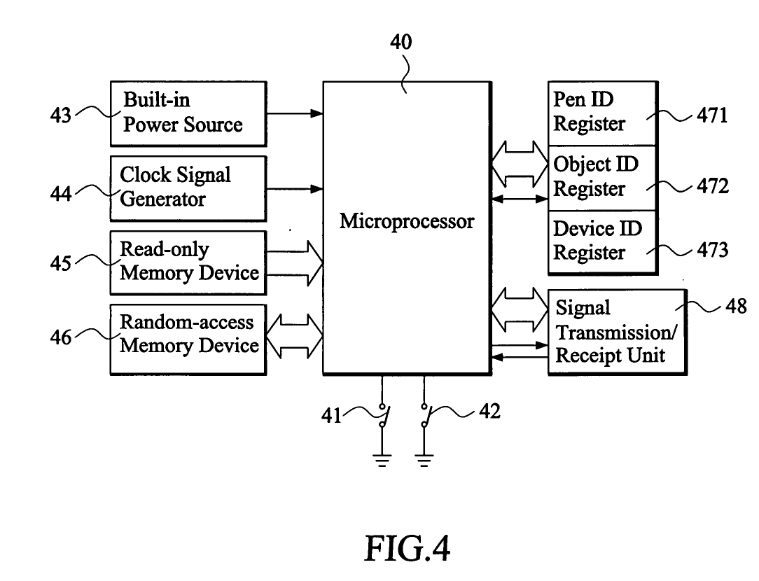

Referring to FIG. 4, a block diagram of a control circuit of the computer object selection/transfer pen 4 is illustrated. The computer object selection/transfer pen 4 comprises a microprocessor 40, powered by a built-in power source 43, such as a battery set. A clock signal generator 44 supplies a series of clock signals to the microprocessor 40. A read-only memory device 45 is coupled to the microprocessor 40 for storage of control programs of the computer object selection/transfer pen 4 and communication protocol for transmission/receipt of signals to/from the computer devices 1, 2. A random-access memory device 46, also coupled to the microprocessor 40, temporarily stores data generated in selection of computer object and transmission/receipt of signals during the operation of the computer object selection/transfer pen 4.

The microprocessor 40 is also connected to a pen ID register 471, an object ID register 472, and a device ID register 473, for respectively storing pen ID (PEN_ID), computer object ID (OBJ_ID), and device ID (DEV_ID).

The microprocessor 40 is also connected to a signal transmission/receipt unit 48, which, under the control of the microprocessor 40, receives the computer object ID (OBJ_ID) and the device ID (DEV_ID) from a source computer device and transmits the computer object ID (OBJ_ID), the pen ID (PEN_ID), and the device ID (DEV_ID) to a target computer device.

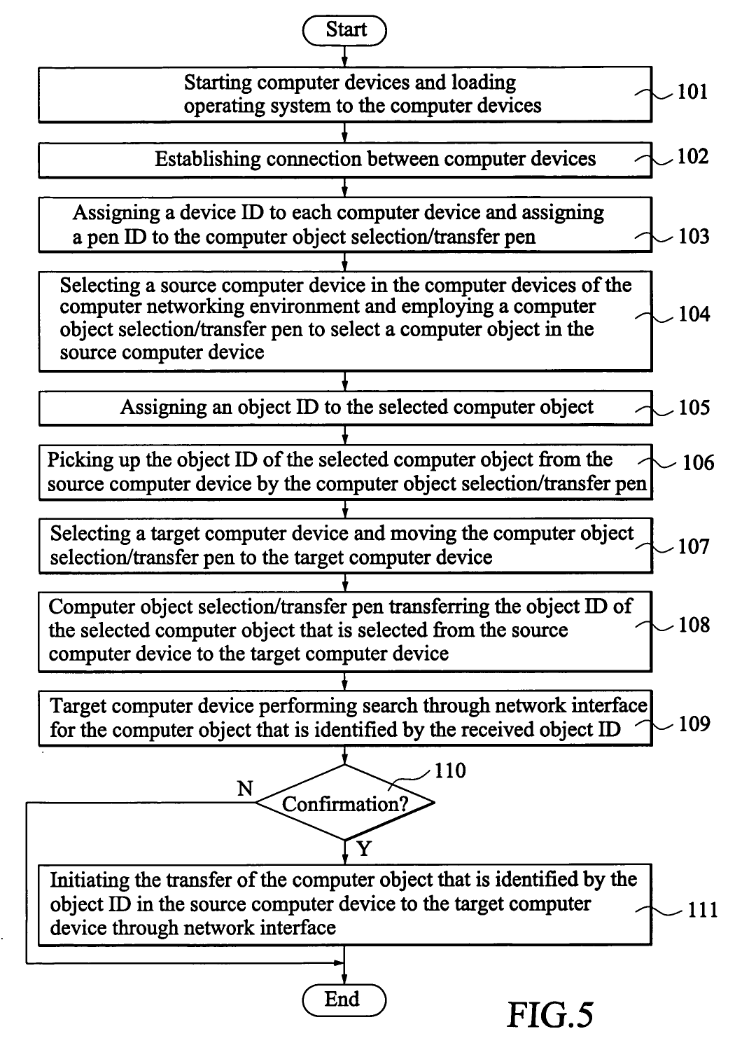

FIG. 5 shows a flowchart of the method in accordance with the present invention, which will be now described with further reference to FIGS. 1 and 4. Firstly, the computer devices 1, 2 are booted up with operation system completely loaded, step 101. On-line connection of each computer device 1, 2 is then established, step 102, and a device ID (DEV_ID) is assigned to each computer device 1, 2 and a pen ID (PEN_ID) is assigned to the computer object selection/transfer pen 4 in advance, step 103. The pre-established device IDs (DEV_ID) of the computer devices 1, 2 and pen ID (PEN_ID) of the computer object selection/transfer pen 4 are stored in the device ID register 473 and the pen ID register 471 of the computer object selection/transfer pen 4, respectively.

When an operator uses the computer object selection/transfer pen 4 to select a computer object to be transferred on the display 11 of the source computer device, which in the embodiment is the first computer device 1, step 104, the selected computer object is assigned an object ID by the source computer device 1, step 105. Thereafter, the computer object selection/transfer pen 4 picks up the object ID of the selected computer object by the signal transmission/receipt unit 48, step 106, and deposits the object ID in the object ID register 472.

Thereafter, the operator physically moves the computer object selection/transfer pen 4 to a target computer device, which in the embodiment illustrated is exemplified by the computer device 2, in the computer networking environment, step 107. The object ID (OBJ_ID) of the computer object that was previously selected from the source computer device 1, as well as the pen ID (PEN_ID) of the computer object selection/transfer pen 4, is then transferred from the computer object selection/transfer pen 4 to the target computer device 2, step 108.

When the target computer device 2 receives the object ID and the pen ID from the computer object selection/transfer pen 4, the target computer device 2 performs search through the network interface 3 for the computer object that is identified by the received object ID, step 109. A confirmation step, step 110, is then taken for confirmation of the transfer of the selected computer object from the source computer device 1 to the target computer device 2, step 110. Positive confirmation of the confirmation step initiates the transfer of the computer object that is identified by the object ID in the source computer device 1 to the target computer device through the network interface 3, step 111.

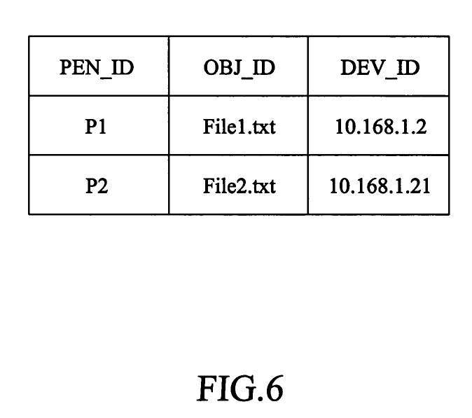

FIG. 6 illustrates an example of a table list for the pen ID (PEN_ID), the object ID (OBJ_ID), and the device ID (DEV_ID). The table list contains at least one pen ID (PEN_ID) for the computer object selection/transfer pen 4, such as P1 and P2 in the illustrated table, at least one selected computer object, such as File1.txt and File2.txt, and the identified address of the target computer device, such as 10.168.1.2 and 10.168.1.21. By means of the table list, correct data transfer between the source computer device and the target computer device can be realized.

In a network architecture including a servo computer, data can be transferred from the source computer device to the target computer device via the servo computer, after the target computer device 2 receives the object ID (OBJ_ID) of the selected computer object and the pen ID (PEN_ID) of the computer object selection/transfer pen 4 from the computer object selection/transfer pen 4.

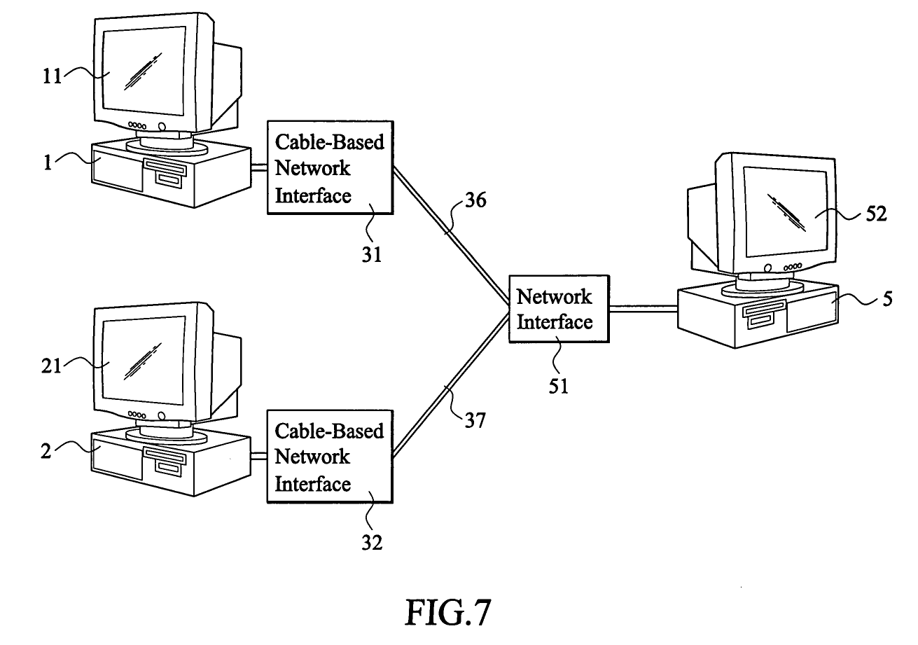

FIG. 7 illustrates an example of the network interface of the system illustrated in FIG. 1, which comprises two computer devices 1, 2 networked to each other by a cable-based network interface and a servo computer. In the embodiment illustrated in FIG. 7, the computer devices 1, 2 are equipped with cable-based network interface 31, 32 respectively and the cable-based network interfaces 31, 32 are connected to a network interface 51 of the servo computer 5 by cables 36, 37 respectively. The servo computer 5 comprises a display 52, which can be for example a touch panel type display. Thus, on-line connection between the two computer devices 1, 2 and the servo computer 5 is effected by the cable-based network interfaces 31, 32, 51.

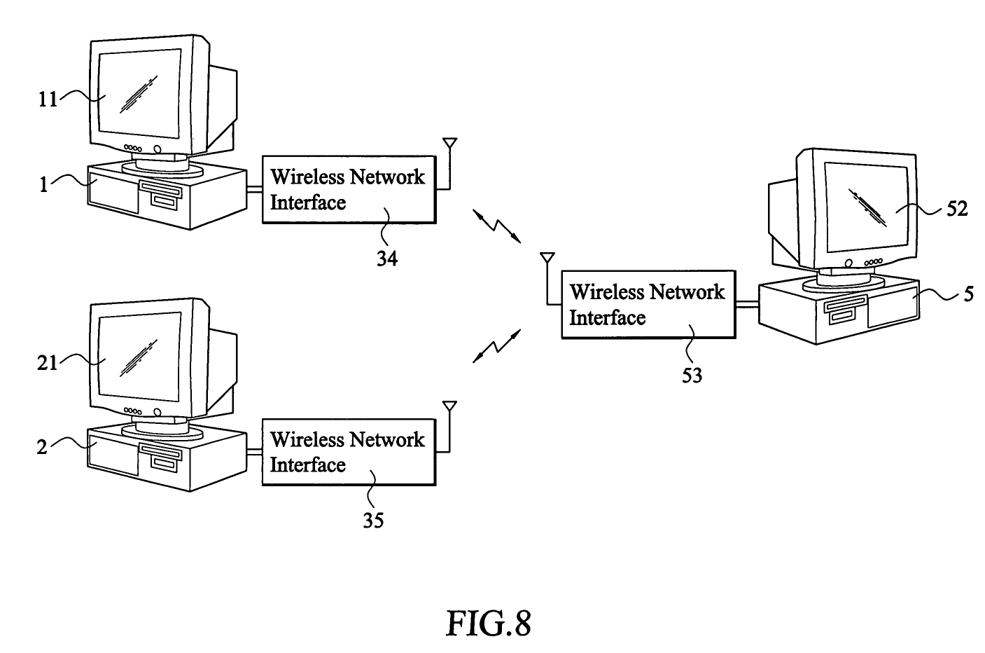

FIG. 8 shows another example, wherein the two computer devices 1, 2 form a computer networking environment with a servo computer by wireless network interfacing. In the embodiment illustrated in FIG. 8, the two computer devices 1, 2 are equipped with wireless network interface 34, 35 respectively and the wireless network interfaces 34, 35 are in communication with a wireless network interface 53 of the servo computer 5 that comprises a display 2 in a wireless manner. Thus, on-line connection between the two computer devices 1, 2 and the servo computer 5 is effected by the wireless network interfaces 34, 35, 53.

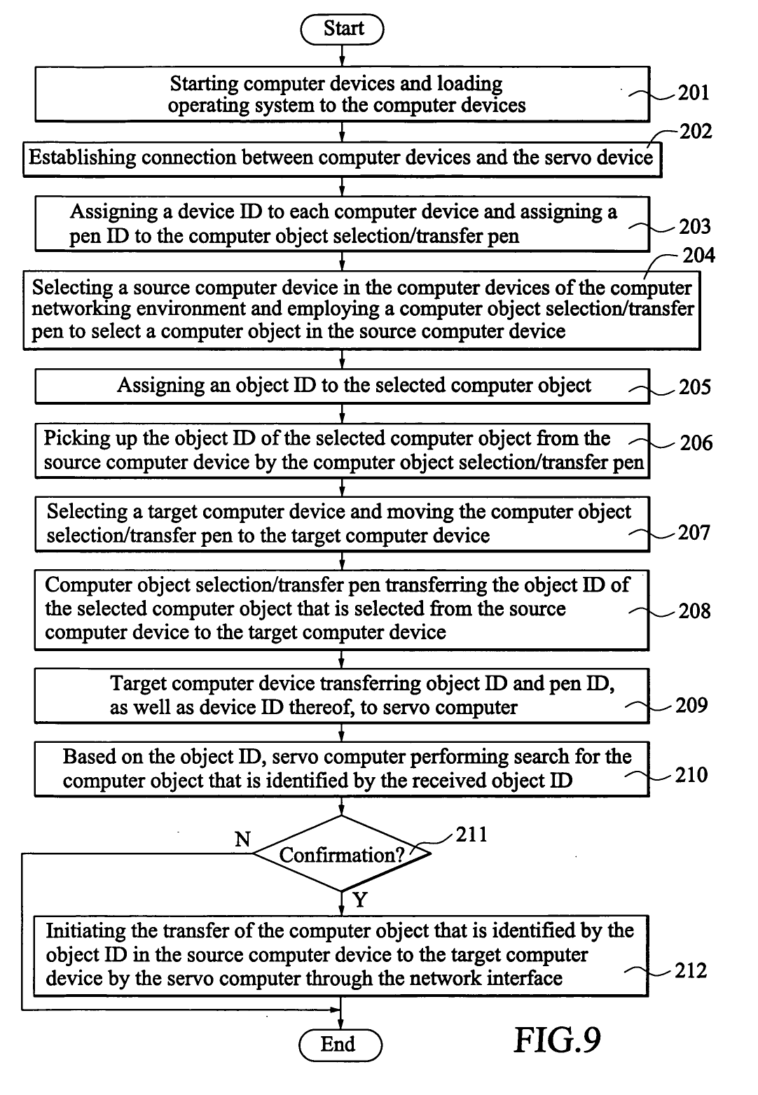

The operation of the computer networking environment illustrated in either FIG. 7 or FIG. 8 is substantially identical to the flowchart in FIG. 5, with some of the steps are performed by the servo computer 5. A flow chart of the operation of the computer system illustrated in FIG. 7 or 8 is shown in FIG. 9, which will now be described with further reference to FIGS. 1, 4, and 6-8.

Firstly, the computer devices 1, 2 and the servo computer 5 are all booted up with operation system completely loaded, step 201. On-line connection of each computer 1, 2, 5 is then established, step 202, and a device ID (DEV_ID) is assigned to each computer device 1, 2 and a pen ID (PEN_ID) is assigned to the computer object selection/transfer pen 4 in advance, step 203. The pre-established device IDs (DEV_ID) of the computer devices 1, 2 and pen ID (PEN_ID) of the computer object selection/transfer pen 4 are stored in the device ID register 473 and the pen ID register 471 of the computer object selection/transfer pen 4, respectively.

When an operator uses the computer object selection/transfer pen 4 to select a computer object to be transmitted on the display 11 of the source computer device 1, step 204, the selected computer object is assigned an object ID by the source computer device 1, step 205. Thereafter, the computer object selection/transfer pen 4 picks up the object ID of the selected computer object by the signal transmission/receipt unit 48, step 206, and deposits the object ID in the object ID register 472.

Thereafter, the operator physically moves the computer object selection/transfer pen 4 to the target computer device 2 in the computer networking environment, step 207. The object ID (OBJ_ID) of the computer object that was previously selected from the source computer device 1, as well as the pen ID (PEN_ID) of the computer object selection/transfer pen 4, is then transferred from the computer object selection/transfer pen 4 to the target computer device 2, step 208.

When the target computer device 2 receives the object ID and the pen ID from the computer object selection/transfer pen 4, the target computer device 2 transfers the object ID and the pen ID, as well as the device ID thereof, to the servo computer 5, step 209. Based on the object ID, the servo computer 5 performs search for the computer object that is identified by the received object ID, step 210. A confirmation step, step 210, is then taken for positive confirmation of the selection of the computer object and also confirmation for transfer of the computer object from the source computer device 1 to the target computer device 2, step 211. Positive response of the confirmation step initiates the transfer of the computer object that is identified by the object ID in the source computer device 1 to the target computer device by the servo computer 5 through the network interface, step 212.

Although the present invention has been described with reference to the preferred embodiments thereof, it is apparent to those skilled in the art that a variety of modifications and changes may be made without departing from the scope of the present invention which is intended to be defined by the appended claims.

1. A method for selection and transfer of a computer object between computer devices in a computer networking environment comprising at least two computer devices and a network interface coupling between the computer devices, the method comprising:
(a) starting the computer devices, loading an operation system into each of the computer devices, and establishing on-line connection between the computer devices;
(b) assigning a device ID that is pre-established to each computer device;
(c) selecting a source computer device in the computer devices of the computer networking environment and employing a computer object selection/transfer pen to select a computer object in the source computer device;
(d) assigning an object ID to the selected computer object;
(e) picking up the object ID of the selected computer object from the source computer device by the computer object selection/transfer pen;
(f) selecting a target computer device in the computer devices of the computer networking environment and moving the computer object selection/transfer pen to the target computer device;
(g) the computer object selection/transfer pen transferring the object ID of the selected computer object that is selected from the source computer device to the target computer device;
(h) the target computer device retrieving the object ID transferred from the computer object selection/transfer pen; and
(i) the target computer device searching and retrieving the computer object identified by the object ID from the source computer device through the network interface.

2. The method as claimed in claim 1, wherein the computer object comprises a computer file.

3. The method as claimed in claim 1, wherein the computer object comprises a computer file folder.

4. The method as claimed in claim 1, wherein the network interface is formed by connecting cable-based network system between the computer devices.

5. The method as claimed in claim 1, wherein the network interface is formed by a wireless network system between the computer devices.

6. The method as claimed in claim 1, wherein the device ID of each computer device comprises a network address of the computer device in the computer networking environment.

7. The method as claimed in claim 1, wherein the computer object selection/transfer pen is assigned a pen ID.

8. The method as claimed in claim 1, further comprising, before step (i), a step of confirmation of transfer of the computer object from the source computer device to the target computer device.

9. The method as claimed in claim 1, wherein the computer devices are equipped with a touch panel type display.

10. The method as claimed in claim 1, wherein the computer object selection/transfer pen comprises at least one function key.

11. A method for selection and transfer of computer object between computer devices in a computer networking environment comprising at least two computer device, a servo device, and a network interface coupling between the computer devices and the servo device, the method comprising:
(a) starting the computer devices and the servo device, loading operation system into the computer devices and the servo device, and establishing on-line connection between the computer devices and the servo device;
(b) assigning a device ID that is pre-established to each computer device;
(c) selecting a source computer device in the computer devices of the computer system environment and employing a computer object selection/transfer pen to select a computer object in the source computer device;
(d) assigning an object ID to the selected computer object;
(e) picking up the object ID of the selected computer object from the source computer device by the computer object selection/transfer pen;
(f) selecting a target computer device in the computer devices of the computer networking environment and moving the computer object selection/transfer pen to the target computer device;
(g) the computer object selection/transfer pen transferring the object ID of the selected computer object that is selected from the source computer device to the target computer device;
(h) the target computer device retrieving the object ID transferred from the computer object selection/transfer pen;
(i) the target computer device transferring the object ID and the device ID to the servo device; and
(j) the servo device transferring the computer object identified by the object ID from the source computer device to the target computer device through the network interface.

12. The method as claimed in claim 11, wherein the computer object comprises a computer file.

13. The method as claimed in claim 11, wherein the computer object comprises a computer file folder.

14. The method as claimed in claim 11, wherein the network interface is formed by connecting cable-based network system among the computer devices and the servo device.

15. The method as claimed in claim 11, wherein the network interface is formed by a wireless network system among the computer devices and the servo device.

16. The method as claimed in claim 11, wherein the device ID of each computer device comprises a network address of the computer device in the computer networking environment.

17. The method as claimed in claim 11, wherein the computer object selection/transfer pen is assigned a pen ID.

18. The method as claimed in claim 11, further comprising, before step (j), a step of confirmation of transfer of the computer object from the source computer device to the target computer device.

19. The method as claimed in claim 11, wherein the computer devices are equipped with a touch panel type display.

20. The method as claimed in claim 11, wherein the computer object selection/transfer pen comprises at least one function key.

21. A device for selection and transfer of computer object from a computer device to a target computer device in a computer networking environment comprising at least two computer device and a network interface coupling between the computer devices, the device comprising:
a microprocessor, controlling the selection and transfer of the computer object;
a pen ID storage unit coupled to the microprocessor for storing a pen ID of a computer object selection/transfer pen;
an object ID storage unit coupled to the microprocessor for storing an object ID that identifies the computer object selected from the source computer device;
a device ID storage unit coupled to the microprocessor for storing a device ID for each computer device; and
a signal transmission/receipt unit coupled to and controlled by the microprocessor to receive the object ID of the computer object selected from the source computer device, the device ID and to transmit the object ID, the pen ID, and the device ID to the target computer device.

22. The device as claimed in claim 21, wherein the network interface is formed by connecting cable-based network system between the computer devices.

23. The device as claimed in claim 21, wherein the network interface is formed by a wireless network system between the computer devices.

24. The device as claimed in claim 21, wherein the network interface comprises a servo device.

25. The device as claimed in claim 21, wherein the computer devices are equipped with a touch panel type display.

26. The device as claimed in claim 21, wherein the computer object selection/transfer pen comprises at least one function key.
